(19) United States
(12) Patent Application Publication
(10) Pub. No.: US 2026/0064922 A1
(43) Pub. Date: Mar. 5, 2026

(54) METHOD FOR SIMULATING THE FLOW OF A FLUID IN CONTACT WITH A MOVING SOLID

(71) Applicant: SAFRAN, PARIS (FR)

(72) Inventors: Melody Elisabeth Laurent CAILLER, MOISSY-CRAMAYEL (FR); Vincent MOUREAU, PETIT-COURONNE (FR)

(73) Assignee: SAFRAN, PARIS (FR)

(21) Appl. No.: 18/716,608

(22) PCT Filed: Dec. 7, 2021
(86) PCT No.: PCT/EP2021/084642

§ 371 Date: Nov. 7, 2024

(51) Int. Cl. G06F 30/28; G06F 113/08

(52) U.S. Cl. CPC G06F 30/28; G06F 2113/08

(57) ABSTRACT

The invention relates to a method for simulating a fluid in contact with a moving solid modelled by a series of fixed positions (X_{A}), the method comprising the steps of: —generating (E1) a fixed lattice (M1); —generating (E2) an auxiliary lattice (M2) of the solid (S) in a first position (X_{A}) wherein each auxiliary lattice (N2) comprises a particle (P) comprising information on the volume (V2) of the auxiliary lattice (N2); —determining (E3) the position (XP_{A}) of the particles (P) in the fixed lattice (M1); —calculating (E4, E5) the volume of the solid (V1ₛ) and the volume fraction of the fluid (ε_{F}) in each fixed lattice (N1) based on the particles (P); —solving (E6) discretised Navier-Stokes equations using the finite volume approach applied to the volume fraction of the fluid (ε_{F}); —and, for each subsequent position (X_{B}, X_{C}) of the solid (S), a step (E7) of moving the particles (P) followed by the determining (E3), calculating (E4, E5) and solving (E6) steps.

### TECHNICAL FIELD

This invention relates to the field of the methods for simulating fluid in contact with a moving solid, in particular a rotating part of an aircraft turboshaft engine.

As is well known, with reference to FIG. 1, an aircraft turboshaft engine 10 extends along a longitudinal axis X and is configured to allow the aircraft to be propelled by the acceleration of an airflow A circulating from upstream to downstream in the turboshaft engine 10. Typically, a turboshaft engine 10 comprises, from upstream to downstream, a fan 11, a low-pressure compressor 12, a high-pressure compressor 13, a combustion chamber 14, a high-pressure turbine 15 and a low-pressure turbine 16. The high-pressure turbine 15 allows to drive the high-pressure compressor 13 in rotation, while the low-pressure turbine 16 allows to drive the low-pressure compressor 12 and the fan 11 in rotation.

Still with reference to FIG. 1, it is known to insert a reducer 20 between the fan 11 and the low-pressure compressor 12 in order to reduce the speed of rotation of the fan 11. This allows to increase the performance of the turboshaft engine 10 with a large-diameter fan 11 and to reduce the noise emitted by the fan 11. In a known manner, with reference to FIG. 2, the reducer 20 comprises toothed wheels 21 which are lubricated by spraying a jet of oil F1 directly onto the teeth 22 at the level of the contact areas Z of the wheels 21. This lubrication allows to prevent the wheels 21 from overheating and limits the mechanical friction.

In practice, the lubrication system must be precisely dimensioned, as an insufficient lubrication is likely to lead to micro-scaling or seizing of the teeth 22 of the wheels 21 and an excessive lubrication to viscous losses reducing the efficiency of the reducer 20. Empirical models based on dimensional analysis, calibration of data from standard experiments or simplified hydrodynamic formulations have been used to dimension the lubrication system. However, such empirical models have a very limited range of validity. It is also known to use bench tests, but these are very expensive and only give access to the macroscopic quantities of the oil F1, such as its temperature and its pressure, at the intake and suction points.

With reference to FIG. 2, to accurately determine the oil flow F1 in the reducer 20, in particular in the vicinity of the teeth 22 at the level of the contact areas Z of the wheels 21, it is known to use digital simulation methods. Such methods consider the oil F1 as a first fluid which interacts with the surrounding air F2 present in the reducer 20, i.e. a second fluid, the assembly of the first fluid and of the second fluid forming a two-phase flow F flowing around a moving solid formed by the toothed wheels 21. Such methods are based on the numerical resolution of the behavioural equations of the two-phase flow F and its interaction with the moving solid and allow to obtain the local magnitudes of the two-phase flow F in the reducer 20 (velocity, temperature, pressure of the oil F1 and of the surrounding air F2, etc.).

As illustrated in FIG. 3, in the approach referred to as interface capture and conformal remeshing finite volume approach, a fixed meshing M_{AA1} models the two-phase flow F, divided into lattices N_{AA1}, each comprising an oil volume fraction F1 and an air volume fraction F2. Such an approach is based on solving the Navier-Stokes equations of the mechanic of the fluids discretised by local flow balance in each lattice N_{AA1}. The toothed wheels 21 are modelled by conditions at the limits E_{AA1} at the level of the boundaries of the meshing M_{AA1}. The rotation R of the wheels 21 is modelled by a series of fixed positions and a new meshing M_{AA1} is created for each position. The disadvantage of such an approach is that it is very costly in terms of calculation time, due to the remeshing required, and not very robust, as it generates very small and distorted lattices N_{AA1}, leading to numerical stability problems.

As illustrated in FIG. 4, the approach referred to as immersed boundary interface capture finite volume approach differs from the previous approach in that the fixed meshing M_{AA2} also represents the toothed wheels 21. For each fixed position of the toothed wheels 21, the boundary Y_{AA2} between the two-phase flow F and the toothed wheels 21 is determined and the lattices N_{AA1} located on the boundary Y_{AA2} are reconstructed, this operation being referred to as “cut-cell”, in order to model only the two-phase flow F and not the teeth 22. This approach is less costly than the previous one, but also less robust, as it reconstructs very small and distorted N_{AA2} lattices.

As illustrated in FIG. 5, the approach referred to as Lattice-Boltzmann interface capture and immersed boundary approach differs from the two previous approaches in that it is based on the Boltzmann equation from the kinetic theory of gases and represents oil F1 and air F2 as particles P_{F1}, P_{F2} propagating and interacting with each other by collision. The distribution function of oil particles P_{F1} and air particles P_{F2} is determined in each lattice N_{AA3} of a fixed meshing M_{AA3} representing both the two-phase flow F and the toothed wheels 21. The toothed wheels 21 are modelled by forcing source terms E_{AA3} applied locally and displaced with the rotation R of the toothed wheels 21. Such an approach is inexpensive in terms of calculation time, but less precise and non-conservative in terms of mass and momentum.

A particle approach, based on the equations of continuum mechanics, is also known, which represents the oil F1, the air F2 and the toothed wheels 21 as particles without using a meshing. The characteristics of the flow carried by each particle are determined by interpolating the characteristics of neighbouring particles. Such an approach is inherently suitable for modelling a two-phase flow F with clearly distinct separate phases but not with dispersed phases, such as oil droplets F1 in the air F2 as is the case in the reducer 20. Also, near-wall phenomena, for which very small particles are required, are often poorly predicted.

The invention is therefore aimed at a method for simulating the flow of a fluid in contact with a moving solid, in particular a rotating part of an aircraft turboshaft engine, in particular the lubricating fluid of a reducer, which is accurate, robust and conservative with a reasonable cost in terms of calculation time.

### SUMMARY OF THE INVENTION

The invention relates to a method for simulating the flow of a fluid in contact with at least one moving solid, in particular a rotating part of an aircraft turboshaft engine, in a delimited area, the movement of the solid being modelled by a series of fixed positions, the method comprising:
A step of generating a fixed meshing of the area comprising a plurality of fixed lattices,
A step of generating an auxiliary meshing of the solid in a first fixed position comprising a plurality of auxiliary lattices whose sum of volumes is equal to the volume of the solid, each auxiliary lattice comprising a particle comprising an information on the volume of said auxiliary lattice,
A step of determining the position of the particles in the fixed meshing corresponding to the first fixed position of the solid,
A step of calculating the solid volume in each fixed lattice from the position and the information on the volume of the particles, so as to locate the solid in said first fixed position in the area,
A step of calculating the volume fraction of fluid in each fixed lattice from the calculated solid volume, so as to locate the fluid in the area,
A step of solving the discretised Navier-Stokes equations according to the finite volume approach and applied to the fluid volume fraction in each fixed lattice, so as to simulate the flow of fluid in contact with the solid in said first fixed position,
And for each subsequent fixed position of the solid, a step of moving the particles into said subsequent fixed position of the solid and then implementing the determination step, calculating step and solving step so as to simulate the flow of fluid in contact with the solid at each position.

Advantageously, the invention allows the flow of a fluid in contact with a moving solid to be simulated accurately and conservatively, based on a solving of the discretised Navier-Stokes equations using the finite volume approach, but also robustly and with a reasonable calculation time. The invention is based on the use of a single fixed meshing not modelled on the real geometry, which is therefore not very complex and quick to generate and comprises lattices of standard shape and volume, making the method robust. The position of the fluid in the fixed meshing is sensibly marked by that of the solid, itself marked by particles each carrying a part of the volume of the solid. The particles are generated using an auxiliary meshing and then moved in the fixed meshing to follow the movement of the solid.

The method according to the invention is therefore more robust and faster than the conformal remeshing approach of the prior art, which requires a complex meshing of the fluid to be generated for each position of the solid. The method according to the invention is also more robust than the cut-cell submerged boundary approach, which tends to generate lattices of uncontrolled shape at the level of the interface. Finally, the method according to the invention is more accurate than the Lattice Boltzmann and particle approaches of the prior art, particularly in the vicinity of the solid. In addition, the method according to the invention has the advantage of being conservative, unlike the Lattice Boltzmann method.

According to a preferred aspect of the invention, the fixed lattices are tetrahedral. According to a preferred aspect, the auxiliary lattices are tetrahedral. This allows the fixed meshing and the auxiliary meshing to be generated quickly and easily, with a sufficient degree of accuracy.

In one aspect, the volume of the auxiliary lattices is less than the volume of the fixed lattices, preferably at least twice less. This allows to ensure the continuity of the fluid volume fraction in the fixed meshing. In other words, this allows the position of the solid to be precisely identified in the fixed meshing, and consequently the position of the fluid described by the volume fraction of fluid in each fixed lattice.

According to one aspect, the determination step allows, for each particle, to determine the fixed lattice in which the center of the particle is located, said fixed lattice forming the position of the particle in the fixed meshing. The position of the particle in the fixed meshing is thus determined simply, conveniently and quickly, preferably by a distance minimisation algorithm providing, for each particle, the fixed lattice whose center is closest to the center of the particle.

According to a preferred aspect, the step of calculating the solid volume of the fixed lattices is implemented by distributing the volume of the auxiliary lattice associated with each particle between the fixed mesh or meshes located around the position of said particle. This allows to identify the position of the solid precisely, without following the shape of the fixed lattices and while ensuring the conservation of the mass.

According to a preferred aspect, the distribution of the volume associated with a particle between the fixed lattice or lattices is inversely proportional to the distance from the fixed lattice to the position of said particle. In other words, the solid volume is distributed according to the distance from the fixed lattices to the particles, which allows the solid to be represented accurately in the fixed meshing.

Preferably, the sum of the solid volumes of the fixed lattices is equal to the sum of the volumes of the auxiliary lattices, to guarantee the conservation of the mass.

According to one aspect, for each fixed lattice, the calculation step allows to calculate the volume fraction of the fixed lattice free of solid and forming the fluid volume fraction. This makes it quick and easy to determine the position of the fluid by simple difference.

According to one aspect, the solving step is applied to a hybrid velocity U of the fluid and of the solid present in each fixed lattice, preferably in the form: [Math 1] U=ε_{F}U_{F}+(1−ε_{F})Uₛ, with U_{F} the velocity of the fluid in the fixed lattice, U_{S} the mean displacement velocity of the solid and ε_{F} the volume fraction of fluid in the fixed lattice.

The choice of a hybrid velocity of the fluid and of the solid instead of the fluid velocity allows to increase the robustness of the simulation method, particularly at the interface between the solid and the fluid.

Preferably, in the solving step, the Navier-Stokes equations comprise a forcing term which ensures that the velocity of the fluid and of the solid at the interface between the solid and the fluid are equal. Such a forcing term allows the simulation method to be robust and accurate at the level of the interface between the solid and the fluid, avoiding any penetration of the fluid into the solid.

In one aspect, the fluid is in the form of a two-phase flow and the volume fraction of fluid in each fixed lattice comprises a volume sub-fraction of a first fluid and of a second fluid separated by an interface, the solving step being implemented by a finite volume approach with interface capture. The simulation method described in the invention is advantageously adapted to the simulation of a two-phase flow, by applying, once the position of the two-phase flow in the area has been identified, a known interface capture approach, which is accurate and conservative. Preferably, the interface capture approach is of the Level-Set Conservative type, in order to accurately determine, while guaranteeing the conservation of the mass, the position of the interface between the first fluid and the second fluid in the two-phase flow.

Advantageously, the simulation method according to the invention allows to model a two-phase flow with a separate phase, i.e. a first fluid and a second fluid that are geographically distinct, and with a dispersed phase, in which the first fluid and the second fluid are mixed, such as droplets of the first fluid in the second fluid,

According to one aspect, the simulation method comprises, after at least one solving step, a step of dividing each fixed lattice located at the level of the interface between the first fluid and the second fluid into a plurality of fixed sub-lattices of sub-volumes. In other words, the volume of a fixed lattice is equal to the sum of the sub-volumes of the associated fixed sub-lattices. The division step is preferably implemented by dynamic meshing adaptation. The simulation method described in the invention thus proposes a robust, low calculation cost and conservative modelling of the two-phase flow, combined with known and accurate resolution using a finite volume approach with interface capture and dynamic meshing adaptation.

According to one aspect, the simulation method comprises, when the sub-volume of at least one fixed sub-lattice is less than the information on the volume of at least one particle located in the fixed sub-lattice, a step of dividing the particle into a plurality of sub-particles comprising an information on the sub-volume less than the sub-volume of the fixed sub-lattice, preferably at least two times less. In other words, the information on the volume of a particle is equal to the sum of the information on the sub-volume of the associated sub-particles. The particles are thus advantageously adapted as a function of the fixed meshing, if necessary between each position of the solid, so as to precisely locate the position of the solid, and consequently that of the fluid, in the fixed meshing. In other words, this allows to guarantee the continuity of the fluid volume fraction in the fixed meshing for each fixed position of the solid.

The invention relates in particular to a method for simulating the lubrication of a reducer of an aircraft turboshaft engine configured to reduce the speed of rotation transmitted to the fan and comprising a plurality of meshed toothed wheels, said moving solid being in the form of at least one toothed wheel and the fluid being in the form of a mixture of lubricant and surrounding air forming a two-phase flow. Preferably, the lubricant is oil.

A simulation method of this kind therefore allows to accurately model the flow of the lubricant in the reducer, particularly at the level of the tooth contact areas. A simulation method of this kind therefore allows to optimise the design of the system for lubricating the reducer, as well as that of the casing and teeth, by evaluating the optimum lubrication, which allows to limit the micro-scaling and the seizure of the teeth while limiting the viscous losses.

The invention also relates to a method for simulating the circulation of a fluid in an aircraft turboshaft engine pump, in particular the fuel circuit, the oil circuit or the cooling circuit. This method allows to optimise the sizing of the pump, by assessing the optimum flow rate and limiting the pressure drop.

The invention also relates to a computing program that implements the simulation method as described above when executed by a computer. The invention also relates to a computing recording medium on which said computing program is stored.

### PRESENTATION OF FIGURES

The invention will be better understood on reading the following description, given by way of example, with reference to the following figures, given by way of non-limiting examples, in which identical references are given to similar objects.

FIG. 1 is a schematic representation of an aircraft turboshaft engine in longitudinal half-section;

FIG. 2 is a schematic functional representation of an aircraft turboshaft engine reducer;

FIG. 3 is a schematic representation of a method for numerically simulating the flow of lubricating oil in the reducer of FIG. 2 using a finite volume approach with interface capture and remeshing in accordance with the prior art;

FIG. 4 is a schematic representation of a method for numerically simulating the flow of lubricating oil in the reducer of FIG. 2 using a finite volume approach with interface capture and cut-cell immersed boundaries according to the prior art;

FIG. 5 is a schematic representation of a method for numerically simulating the flow of lubricating oil in the reducer of FIG. 2 using a Lattice-Boltzmann approach with immersed boundaries according to the prior art;

FIG. 6 is a schematic representation of the modelling of the lubricating oil and the toothed wheels of the reducer in the simulation method according to one embodiment of the invention in several fixed positions;

FIG. 7A and

FIG. 7B are schematic representations of the steps in the simulation method shown in FIG. 6;

FIG. 8 is a schematic representation of the fixed meshing generation step of the simulation method of FIGS. 7A and 7B;

FIG. 9 is a schematic representation of the step of generating an auxiliary meshing of the simulation method of FIGS. 7A and 7B;

FIG. 10A is a schematic representation of the step of determining the position of the particles of the auxiliary meshing of FIG. 9 on the fixed meshing of FIG. 8 of the simulation method of FIGS. 7A and 7B;

FIG. 10B is a close schematic representation of FIG. 10A;

FIG. 11 is a schematic representation of the step for calculating the solid volume in the fixed lattices of the simulation method shown in FIGS. 7A and 7B;

FIG. 12 is a schematic representation of the step of calculating the volume fraction of fluid in the fixed lattices and the solving step of the simulation method of FIGS. 7A and 7B;

FIG. 13 is a schematic representation of the particle displacement step of the simulation method shown in FIGS. 7A and 7B;

FIG. 14 is a schematic representation of the simulation method according to an alternative embodiment of the invention;

FIG. 14B is a schematic representation of the step of refining the fixed meshing of the simulation method in FIG. 14A and

FIG. 14C is a schematic representation of the step of dividing the auxiliary meshing of the simulation method in FIG. 14A.

It should be noted that the figures set out the invention in detail in order to implement the invention, said figures of course being able to be used to better define the invention if necessary.

### DETAILED DESCRIPTION OF THE INVENTION

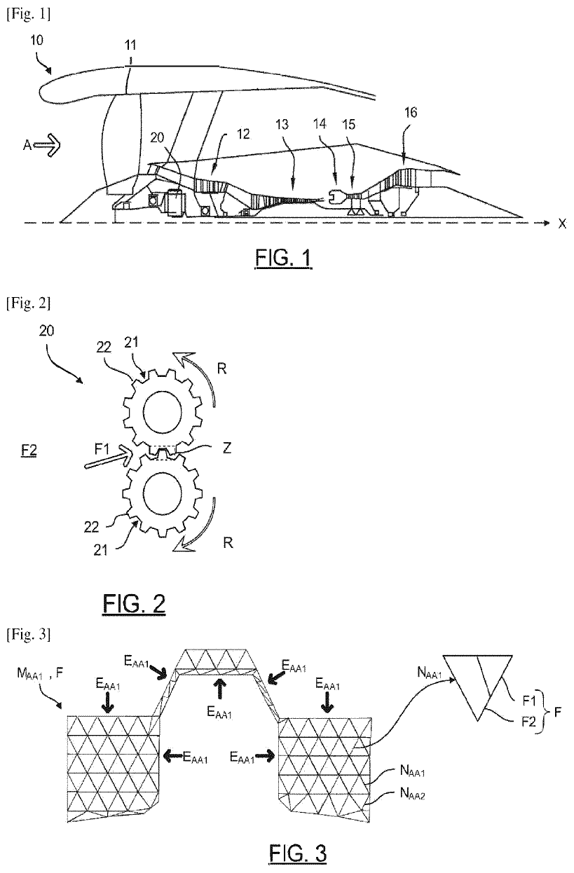

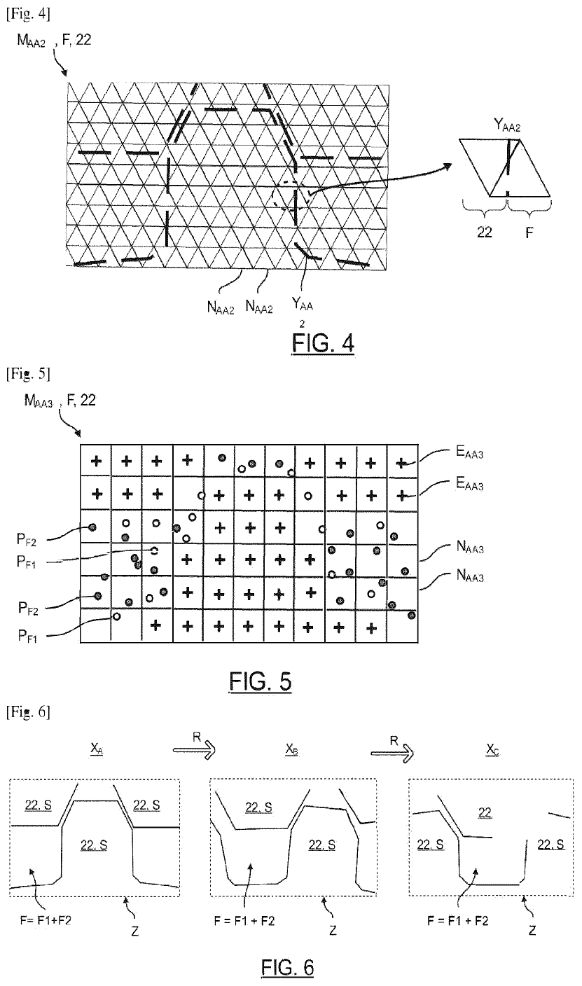

As is well known, with reference to FIG. 1 and as described in the preamble, an aircraft turboshaft engine 10 extends along a longitudinal axis X and is configured to allow the aircraft to be propelled from the acceleration of an air flow A circulating from upstream to downstream in the turboshaft engine 10. Typically, a turboshaft engine 10 comprises, from upstream to downstream, a fan 11, a low-pressure compressor 12, a high-pressure compressor 13, a combustion chamber 14, a high-pressure turbine 15 and a low-pressure turbine 16. The high-pressure turbine 15 allows to drive the high-pressure compressor 13 in rotation, while the low-pressure turbine 16 allows to drive the low-pressure compressor 12 and the fan 11 in rotation.

Still referring to FIG. 1 and as described in the preamble, it is known to insert a reducer 20 between the fan 11 and the low-pressure compressor 12 in order to reduce the speed of rotation of the fan 11. This allows to increase the performance of the turboshaft engine 10 with a large-diameter fan 11 and to reduce the noise emitted by the fan 11. In a known manner, with reference to FIG. 2, the reducer 20 comprises toothed wheels 21 which are lubricated by spraying a jet of oil F1 directly onto the teeth 22 at the level of the contact areas Z of the wheels 21. This lubrication allows to prevent the wheels 21 from overheating and limits the mechanical friction.

In practice, the lubrication system must be precisely dimensioned, as an insufficient lubrication is likely to lead to micro-scaling or seizing of the teeth 22 of the wheels 21 and an excessive lubrication to viscous losses reducing the efficiency of the reducer 20.

With reference to FIG. 6, in order to optimise the sizing of the lubrication system of the reducer 20, the invention proposes a method for simulating the flow of a fluid F in contact with a moving solid S in a delimited area Z. In the example shown in FIG. 6, the fluid F refers to both the oil F1 and the surrounding air F2 in the reducer 20, which together form a two-phase flow. The solid S refers to the toothed wheels 21 and the simulation area Z chosen is the contact area of the teeth 22 of two toothed wheels 21. However, it goes without saying that the area Z could be extended to a more or less vast portion of the reducer, or even to the entire reducer. The rotational movement R of the toothed wheels 21 is also modelled by a series of fixed positions X_{A}, X_{B}, X_{C}.

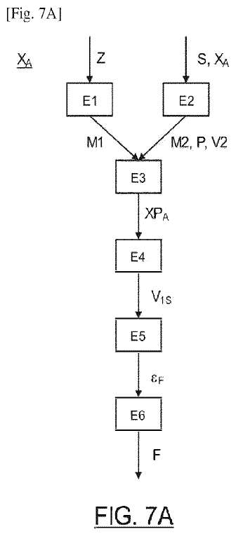

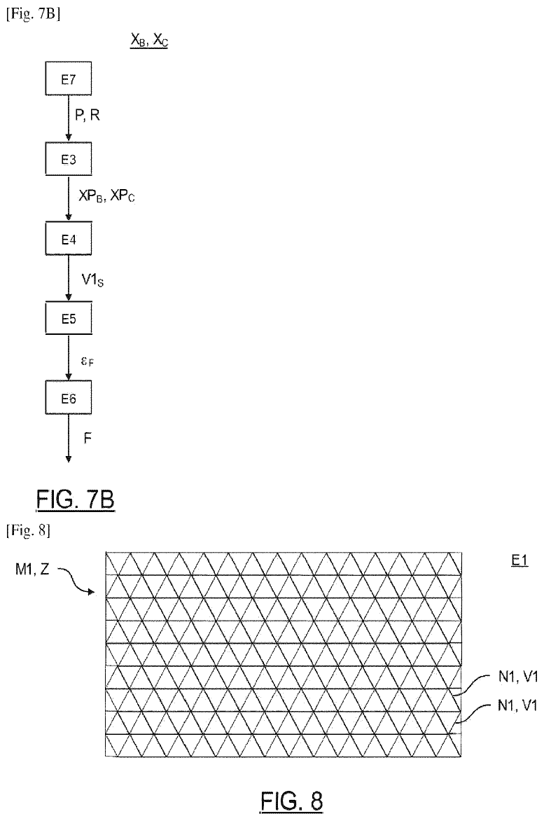

According to the invention, with reference to FIGS. 6 and 7A, the simulation method comprises:
A step E1 for generating a fixed meshing M1 of the area Z comprising a plurality of fixed lattices,
A step E2 of generating an auxiliary meshing M2 of the solid S in a first fixed position X_{A} comprising a plurality of auxiliary lattices whose sum of volumes V2 is equal to the volume of the solid S, each auxiliary lattice comprising a particle P comprising an information on the volume V2 of said auxiliary lattice,
A step E3 of determining the position XP_{A} of the particles P in the fixed meshing M1 corresponding to the first fixed position X_{A} of the solid S,
A step E4 of calculating the solid volume V1_{S} in each fixed lattice from the position XP_{A} and the information on the volume V2 of the particles P, so as to locate the solid S in said first fixed position X_{A} in the area Z,
IA step E5 of calculating the volume fraction of fluid ε_{F} in each fixed lattice from the solid volume V1_{S} calculated, so as to locate the fluid F in the area Z,
A step E6 of solving the discretised Navier-Stokes equations according to the finite volume approach and applied to the fluid volume fraction ε_{F} in each fixed lattice, so as to simulate the fluid flow F in contact with the solid S in said first fixed position X_{A},
And, with reference to FIGS. 6 and 7B, for each subsequent fixed position X_{B}, X_{C} of the solid S, a step E7 of moving the particles P into said subsequent fixed position X_{B}, X_{C} of the solid S and then implementing the steps of determining E3, calculating E4, E5 and solving E6 described above, so as to simulate the flow of fluid F in contact with the solid S in each position X_{A}, X_{B}, X_{C}.

Thanks to the simulation method of the invention, it is possible to numerically simulate the flow of a fluid F around a moving solid S, combining accuracy, robustness, conservation of the mass and quantity and reasonable calculation time. To achieve this, the simulation method is based on the use of a single fixed meshing M1 that does not follow the shape of the fluid F, combined with a resolution using the finite volume approach. This allows to retain only the advantages of the prior art finite volume approaches, namely the precision and the conservation of the mass and the momentum.

More precisely, in the simulation method of the invention, the position of the fluid F in the fixed meshing M1 is advantageously determined via that of the solid S, itself determined by an assembly of particles P representing the solid S, which are mobile to represent its movement. The fixed meshing M1 is therefore quick and easy to create, with fixed lattices of a standard shape and size that make the simulation method more robust. This method avoids the need to generate a complex meshing with deformed lattices for each position X_{A}, X_{B}, X_{C} of the solid S, as is the case with conventional remeshing approaches in the prior art.

As will be seen later, such a simulation method is particularly suitable for modelling a two-phase flow F, in particular with a dispersed phase, as is the case in the reducer 20 where the oil F1 is sprayed onto the toothed wheels 21 and thus forms droplets in the surrounding air F2. It goes without saying, however, that the invention is not limited to a method for simulating the flow of oil F1 to ensure the lubrication of the toothed wheels 21 of a reducer 20 of an aircraft turboshaft engine 10. The invention allows to simulate the flow of any fluid F in contact with any moving solid or solids, in particular in the form of a rotating part of an aircraft turboshaft engine. In particular, the invention allows to optimise the design of fuel circuit, oil circuit and cooling circuit pumps, by limiting the pressure drops and by evaluating the optimum flow rate of the fluid F.

What follows is a more detailed description of the steps in the simulation method according to the invention in the context of the lubrication of a reducer 20 of an aircraft turboshaft engine 10.

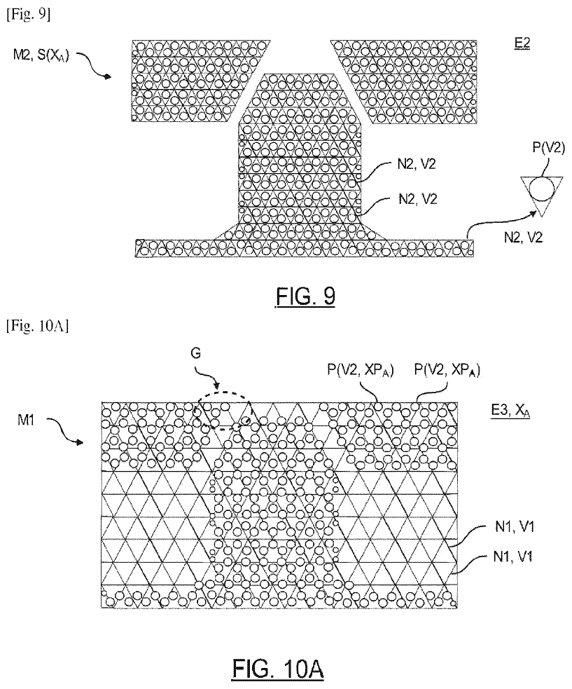

As described previously, the simulation method begins with a step of generating E1, E2 a fixed meshing M1, illustrated in FIG. 8, and an auxiliary meshing M2, illustrated in FIG. 9. With reference to FIG. 8, the fixed meshing M1 comprises fixed lattices N1 and models a delimited area Z of interest of the reducer 20, namely in this example the contact area between the teeth 22 of two toothed wheels 21 illustrated in FIG. 6. In the example shown in FIG. 8, the area Z has a rectangular shape and the fixed meshing M1 therefore extends in two dimensions and comprises triangular-shaped fixed lattices N1. The meshing M1 could also extend in three dimensions to represent an area Z in three dimensions and comprise fixed tetrahedral lattices N1. Such a meshing M1 is advantageously simple and quick to generate. It goes without saying that the fixed lattices N1 could comprise a different shape, such as a hexagonal shape. The generation step E1 thus allows to obtain a fixed meshing M1 of an area Z of interest where it is desired to know the behaviour of the fluid F in contact with the solid S. At the end of the generation step E1, the position of the fluid F and of the solid S on the fixed meshing M1 is undetermined and will be subsequently, thanks to the auxiliary meshing M2.

With reference to FIG. 9, the auxiliary meshing M2 comprises auxiliary lattices M2 and models only the solid S in a first fixed position X_{A}, preferably in the area Z. In other words, the auxiliary meshing M2 has the geometric shape of the solid S, namely in this example the shape of the teeth 22 in contact with two toothed wheels 21 of the reducer 20. Each auxiliary lattice N2 thus comprises a volume V2 corresponding to a portion of the volume of the solid S, which is equal to the sum of the volumes V2 of the auxiliary lattices N2.

Still referring to FIG. 9 and as previously described, each auxiliary lattice N2 comprises a particle P which comprises an information on the volume V2 of the auxiliary lattice N2 with which it is associated. In this way, the particles P together, and on their own, allow to determine the geometry of the solid S in the first position X_{A}. In the example shown in FIG. 9, the auxiliary lattices N2 are of the same type as the fixed lattices N1, i.e. triangular in shape, and comprise a volume V2 less than the volume V1 of the fixed lattices N1, preferably at least twice less. Such an auxiliary meshing M2 allows the position of the solid S, and consequently that of the fluid F, in the fixed meshing M1 to be determined precisely, as will be seen later.

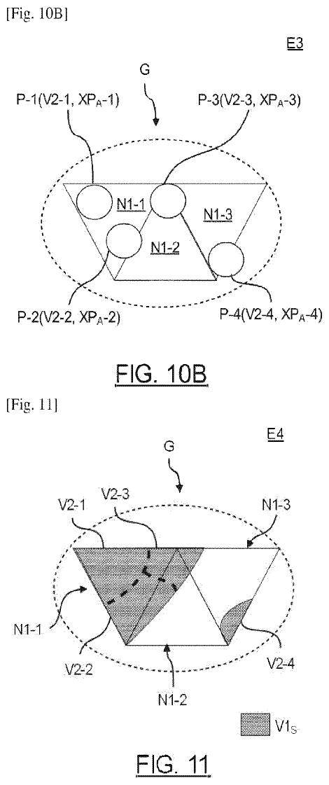

With reference to FIG. 10A and as described above, a step E3 of determining the position XP_{A} of the particles P in the fixed meshing M1 is then carried out. With reference to FIG. 10B which represents an enlargement G of a portion of the fixed meshing M1 at the end of the determination step E3, that the particles P associated with the fixed meshing M1 may be inscribed in a fixed lattice N1 or extend by overlapping several fixed lattices N1. In the example shown in FIG. 10B, a first particle P-1 is inscribed in a first fixed lattice N1-1, while a second, a third and a fourth particle P-2, P-3, P-4 overlap several fixed lattices N1-1, N1-2, N1-3.

As illustrated in FIG. 10B, in practice, the position XP_{A} of a particle P in the fixed meshing M1 corresponds to the fixed lattice N1 in which the center of the particle P is located and is determined by a distance minimisation algorithm. In other words, the position XP_{A} of a particle P is determined by measuring the distance separating the particle P from the center of neighbouring fixed lattices N1 and identifying the fixed lattice N1 with the smallest distance. In this example, the position XP_{A}-1, XP_{A}-2 of the first particle P-1 and of the second particle P-2 correspond to the first fixed lattice N1-1. The position XP_{A}-3 of the third particle P-3 and the position XP_{A}-4 of the fourth particle P-4 correspond to a second fixed lattice N1-2 and a third fixed lattice N1-3 respectively.

At the end of the determination step E3, each particle P thus comprises an information on the volume V2 and its position XP_{A} in the fixed meshing M1. It should be noted that the auxiliary meshing M2 is no longer used at the end of the determination step E3. In other words, the auxiliary meshing M2 is only used to generate particles P to model the solid S.

With reference to FIG. 11, the information on the volume V2 and the position XP_{A} of each particle P in the fixed meshing M1 are then used, in the calculation step E4, to locate the solid S in the first position X_{A} in the fixed meshing M1, more precisely, by determining the solid volume V1_{S} in each fixed lattice N1. To do this, the volume V2 associated with each particle P is distributed between the fixed lattices N1 located around the position XP_{A} of said particle P. Advantageously, such a calculation step E4 guarantees the mass conservation by ensuring that the volume V2 of the assembly of the particles P is equal to the volume of volume V1_{S} of the assembly of the fixed lattices N1.

In practice, the solid volume V1_{S} in a fixed lattice N1 satisfies the following equation:

$$V {1}_{S} = {\sum }_{P neighbours} V 2 W 2 \qquad [ Math 2 ]$$

with W2 an interpolation weight inversely proportional to the distance between the particle P and the fixed lattice N1. In other words, the closer a fixed lattice N1 is to a particle P, the more of the volume V2 associated with said particle P it recovers. FIG. 11, the position XP_{A} of the first particle P1 and of the second particle P-2 are closer to the first fixed lattice N1-1, while the third particle P-3 is equidistant from the three fixed lattices N1-1, N1-2, N1-3. The first particle P-1 and the second particle P-2 thus make a majority contribution to the solid volume V1s in the first fixed lattice N1-1, while the third particle P-3 makes an equal contribution to the solid volume V1_{S} in the three fixed lattices N1-1, N1-2 and N1-3. This allows to precisely locate the solid S at the first position X_{A} in the fixed meshing M1.

As described previously, to increase the accuracy of the localisation of the solid S in the fixed meshing M1, the volume V2 associated with the particles P is less than the volume V1 of the fixed lattices N1. In other words, a large number of particles P with a small volume V2 allows a better localisation of the solid S than a small number of particles P with a large volume V2. In particular, this ensures the continuity in the distribution of the solid S between the fixed lattices N1.

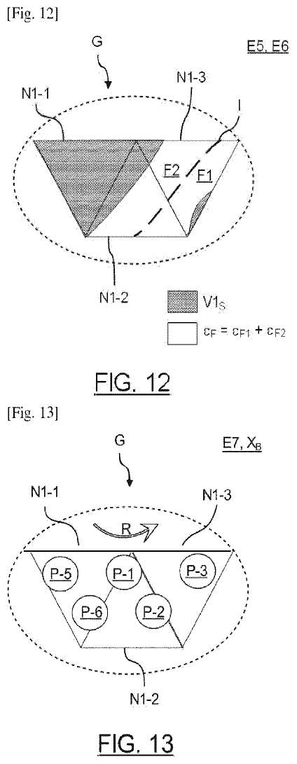

With reference to FIG. 12, the solid volume V1_{S} in each fixed lattice N1 then allows, in the calculation step E5, to obtain the volume fraction ε_{F} of fluid F in each fixed lattice N1, in practice by the following formula:

$${ε}_{F} = max ( 1 - V {1}_{S} / V 1 ; 1 ) \qquad [ Math 3 ]$$

where V1 is the volume of a fixed lattice N1 and V1_{S}/V1 is the solid volume fraction. In other words, the volume fraction of fluid ε_{F} in each fixed lattice N1 corresponds to the fraction of the fixed lattice N1 not occupied by the solid S. It is thus understood that the accuracy of the determination of the volume fraction of fluid ε_{F} in each fixed lattice N1 is directly linked to that of the solid volume V1_{S}.

It is specified that the volume fraction ε_{F} of fluid F of each fixed lattice N1 is between 0 and 1, equal to 1 when the fixed lattice N1 comprises only fluid F and equal to 0 when it comprises only solid S, such as the first fixed lattice N1-1 of FIG. 12. The fixed lattices N1 comprise a volume fraction ε_{F} that is not zero and not equal to 1, such as the second and the third fixed lattices N1-2, N1-3 in FIG. 12 are located at the level of the interface between the fluid F and the solid S.

Still referring to FIG. 12 and as described previously, the simulation method then comprises a step E6 of solving the discretised Navier-Stokes equations using the finite volume approach and applied to the fluid volume fraction ε_{F} previously calculated in each fixed lattice N1. In other words, only the portion of fluid F in each fixed lattice N1 is solved to simulate the flow of fluid F, the solid volume V1_{S} being used solely to locate fluid F in the fixed meshing M1. As the Navier-Stokes equations are known to the person skilled in the art, they are not repeated here.

Such a solving step E6 is advantageously based on the Navier-Stokes equations which govern the behaviour of a fluid, unlike the Lattice-Boltzmann and particle approaches of the prior art based respectively on the kinetic theory of gases and on the mechanics of continuous media. The finite volume approach used for the solving step E6 also has the advantage of being accurate and conservative, based on a local flow balance in each fixed lattice N1. As the finite volume approach is already known to the person skilled in the art, it will not be described further.

It is simply specified that in order to increase the robustness of the simulation method, in particular at the interface between the fluid F and the solid S, the Navier-Stokes equations are written for a hybrid velocity U of the fluid F and of the solid S present in each fixed lattice N1, preferably in the form:

$$U = {ε}_{F} {U}_{F} + ( 1 - {ε}_{F} ) {U}_{S} \qquad [ Math 4 ]$$

with U_{F} the velocity of the fluid in the fixed lattice N1, U_{S} the average displacement velocity of the solid S and ε_{F} the volume fraction of fluid in the fixed lattice N1. In addition, a forcing term is added to the Navier-Stokes equations to ensure that the velocity of the fluid and of the solid at the interface between the solid and the fluid are equal. Such a forcing term allows the simulation method to be robust and accurate at the level of the interface between the solid S and the fluid F, in particular by avoiding any penetration of the fluid F into the solid S.

In practice, in the case of the reducer 20, the fluid F is in the form of a two-phase flow, formed by the lubricating oil F1 within the surrounding air F2. To determine the interface between the oil F1 and the surrounding air F2 and solve both the flow of oil F1 and surrounding air F2, the finite volume approach used is of the interface capture type, more specifically based on the conservative Level-Set method. Such an approach indirectly determines the volume subtraction of oil F1 and surrounding air F2 within the fluid volume fraction ε_{F} in each fixed lattice N1, by solving a transport equation of a function indicating the distance to the interface I. Such an approach is familiar to the person skilled in the art and will not be described further.

At the end of the solving step E6, the flow of the fluid F around the solid S in the first position X_{A} is determined, i.e. the local characteristics of the fluid F (velocity, pressure, temperature, etc.) are resolved.

With reference to FIG. 13, to resolve the fluid flow F in the second position X_{B} of the solid S, a displacement step E7 is implemented to displace R the particles P so that they model the solid S in the second position X_{B}. We thus specify that the particles P are Lagrangian in a fixed meshing M1 which is Eulerian. As illustrated in FIG. 6, the new position XP_{B} of the particles P in the fixed meshing M1 is then determined by repeating the determination step E3 described above. The solid volume V1_{S} and the volume fraction of fluid ε_{F} in each fixed lattice N1 are then recalculated from the new position XP_{B} of the particles P by repeating the calculation steps E4, E5 previously described. A new solving step E6 is then implemented on the basis of the recalculated fluid volume fraction to simulate the fluid flow F in the second position X_{B} of the solid S. And so on for each subsequent position X_{C} of the solid S in order to simulate the flow of the fluid F for each position X_{A}, X_{B}, X_{C}, of the solid S.

To summarise, the method according to the invention allows to simulate the flow of a fluid around a moving solid S by applying a finite volume approach in a fixed meshing M1 not based on the geometry of the fluid F. The geometry of the fluid F is determined via that of the solid S, which is modelled by particles P associated with a portion of the volume of the solid S and occupying several successive positions XP_{A}, XP_{B}, XP_{C}. An auxiliary meshing M2 is used to generate the particles P. Such an approach has the advantage of being accurate, robust, conservative and of reasonable calculation time, in particular for simulating a two-phase flow F with a dispersed phase, such as the lubrication of a reducer 20.

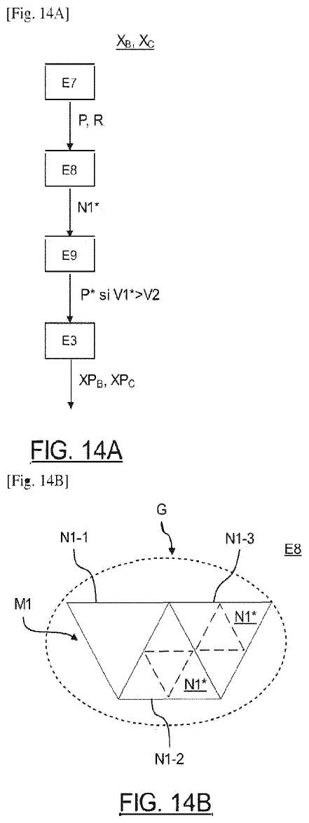

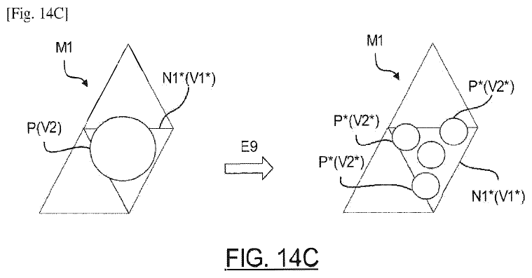

With reference to FIG. 14A, an alternative embodiment of the invention suitable for the two-phase flows F is described below, in which, at the end of one or more solving steps E6, a refinement step E8 of the fixed meshing M1 and a division step E9 of the auxiliary meshing M2 are implemented in order to increase the accuracy of the following solving step E6. In other words, once the two-phase flow F has been simulated for a given position X_{A}, X_{B}, X_{C} of the solid S, the particles P are moved E7 and then the fixed meshing M1 and the particles P are adapted during an additional refinement step E8 and division step E9 with a view to simulating the two-phase flow F more accurately for the next position X_{B}, X_{C} of the solid S.

As a reminder, in the context of a two-phase flow F as illustrated in FIG. 12, a solving step E6 allows to determine the interface I between the first fluid F1 and the second fluid F2 of the two-phase flow F as well as the local characteristics of the first fluid F1 and of the second fluid F2, for a position X_{A}, X_{B}, X_{C} of the solid S.

With reference to FIG. 14B, the refinement step E8 of the fixed meshing M1 is implemented by dividing the fixed lattices N1 located at the level of the interface I into fixed sub-lattices N1* comprising a sub-volume V1*. In the example of FIGS. 12 and 14B combined, the refinement step E8 is thus implemented in the fixed lattices N1 comprising both the first fluid F1 and the second fluid F2, namely the second fixed lattice N1-2 and the third fixed lattice N1-3. The sum of the sub-volumes V1* of the fixed sub-lattices N1* from the same fixed lattice N1 is equal to the volume V1 of said fixed lattice N1. Such a refinement step E8 is known per se to the person skilled in the art as “dynamic meshing adaptation” and allows the interface I between the first fluid F1 and the second fluid F2 to be accurately determined.

While such a refinement step E8 allows to better describe the interface I between the first fluid F1 and the second fluid F2, it is also likely to generate fixed sub-lattices N1* whose sub-volume V1* is less than the information on the volume V2 of the particles P, causing potential inaccuracies during the calculation steps E4, E5 of the solid volume V1_{S} and of the fluid volume fraction ε_{F}.

With reference to FIG. 14C, to avoid this inconvenience, the division step E9 is thus implemented on the particles P whose information on the volume V2 is greater than the sub-volume V1* of the fixed sub-lattices N1* in which they are located. The particles P meeting these criteria are each divided into several sub-particles P* comprising an information on sub-volume V2*. Such a division step E9 could also be implemented on the auxiliary meshing M2 and then transferred to the particles P, although this would be time-consuming and would require the auxiliary meshing M2 to be retained at the end of the determination step E3. It is specified that the sum of the information on the sub-volume V2* of the sub-particles P* originating from the same particle P is equal to the information on the volume V2 of said particle P so as to ensure the conservation of the mass of the solid S. In practice, the information on the sub-volume V2* of the sub-particles P* is preferably chosen to be at least twice less than the volume V1* of the fixed sub-lattices N1* to ensure the continuity of the fluid volume fraction ε_{F}.

Following the refinement step E8 and division step E9, the determination step E3 is implemented with the assembly of particles P, on the one hand, deprived of particles P whose information on the volume V2 is greater than the sub-volume V1* of the fixed sub-lattices N1* in which they are located, and on the other hand, completed with the sub-particles P* generated during the division step E9. The calculation steps E4, E5 and the solving step E6 are then implemented in the refined fixed meshing M1 comprising the assembly of the lattices N1, on the one hand, deprived of the fixed lattices N1 located at the level of the interface I, and on the other hand, completed with the fixed sub-lattices N1* generated during the refinement step E8.

This alternative embodiment thus allows to improve the solving of the interface I between the first fluid F1 and the second fluid F2 of a tow-phase flow F without affecting the determination of the position of the solid S and consequently that of the fluid F, in the fixed meshing M1.

1-10. (canceled)

11. A method for dimensioning a lubrication system of a reducer of an aircraft turboshaft engine, said reducer being configured to reduce the speed of rotation transmitted to a fan of the aircraft turboshaft engine and comprising a plurality of meshed toothed wheels, said lubrification system being configured to project a spray of lubricant on the toothed wheels of the reducer, said method being implemented by computer and modelling the movement of the toothed wheels of the reducer by a series of fixed positions, the fluid being in the form of a mixture of lubricant and surrounding air forming a two-phase flow, the method comprising:
A step of generating a fixed meshing of an area of the reducer, the fixed meshing comprising a plurality of fixed lattices,
A step of generating an auxiliary meshing of at least one toothed wheel of the reducer in a first fixed position, the auxiliary meshing comprising a plurality of auxiliary lattices whose sum of volumes is equal to the volume of the toothed wheel, each auxiliary lattice comprising a particle comprising an information on the volume of said auxiliary lattice,
A step of determining the position of the particles in the fixed meshing corresponding to the first fixed position of the toothed wheel,
A step of calculating the toothed wheel volume in each fixed lattice from the position and the information on the volume of the particles, so as to locate the toothed wheel in said first fixed position in the area of the reducer,
A step of calculating the volume fraction of fluid in each fixed lattice from the calculated toothed wheel volume, so as to locate the fluid in the area of the reducer, said volume fraction of fluid comprising a volume sub-fraction of lubricant and a volume sub-fraction of surrounding air separated by an interface,
A step of solving the discretised Navier-Stokes equations according to the finite volume approach with interface capture and applied to the fluid volume fraction in each fixed lattice, so as to determine the output local characteristics of the fluid in contact with the toothed wheel in said first fixed position,
And, for each subsequent fixed position of the toothed wheel, a step of moving the particles into said subsequent fixed position of the toothed wheel and then implementing the determination step, the calculating step and the solving step so as to determine the output local characteristics of the fluid in contact with the toothed wheel at each said fixed position, so as to dimension the lubrification system of the reducer, the local characteristics of the fluid comprising at least one the following data: local velocity of the lubricant, local pressure of the lubricant and local temperature of the lubricant.

12. The dimensioning method according to claim 11, wherein the volume of said auxiliary lattices is less than the volume of the fixed lattices.

13. The dimensioning method according to claim 11, wherein the determination step allows, for each particle, to determine the fixed lattice in which the center of the particle is located, said fixed lattice forming the position of the particle in the fixed meshing.

14. The dimensioning method according to claim 11, wherein the calculation step allows, for each fixed lattice, to calculate the volume fraction of the fixed lattice free of toothed wheel and forming the fluid volume fraction.

15. The dimensioning method according to claim 11, wherein the solving step is applied to a hybrid velocity of the fluid and of the toothed wheel present in each fixed lattice.

16. The dimensioning method according to claim 15, wherein the hybrid velocity U of the fluid and of the toothed wheel present in each fixed lattice is in the form: [Math 5] U=ε_{F}U_{F}+(1−ε_{F})U_{S}, with U_{F} the velocity of the fluid in the fixed lattice, U_{S} the mean displacement velocity of the toothed wheel and ε_{F} the volume fraction of fluid in the fixed lattice.

17. The dimensioning method according to claim 11, comprising, after at least one solving step, a step of refining each fixed lattice located at the level of the interface between the lubricant and the surrounding air into a plurality of fixed sub-lattices of sub-volumes.

18. The dimensioning method according to claim 17, comprising, when the sub-volume of at least one fixed sub-lattice is less than the information on the volume of at least one particle located in the at least one fixed sub-lattice, a step of dividing the at least one particle into a plurality of sub-particles comprising an information on the sub-volume less than the sub-volume of the at least one fixed sub-lattice.

19. A computing program implementing the dimensioning method according to claim 11 when executed by a computer.
